(19) United States
(12) Patent Application Publication
(10) Pub. No.: US 2002/0139659 A1
(43) Pub. Date: Oct. 3, 2002

(54) Method and apparatus for sterilization of fluids using a continuous capillary discharge atmospheric pressure plasma shower

(75) Inventors: Dong Woo Yu, Demarest, NJ (US); Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(73) Assignee: SKION CORPORATION

(21) Appl. No.: 09/823,985

(22) Filed: Apr. 3, 2001

(51) Int. Cl. B01J 19/08

(52) U.S. Cl. 204/164; 422/186

(57) ABSTRACT

A plasma apparatus for treating a fluid includes a fluid conduit, a first metal electrode and a second metal electrode mounted in the fluid conduit and receiving a potential, a capillary dielectric between the first and second metal electrodes, wherein the capillary dielectric has at least one capillary, a shield body surrounding at least a portion of the first metal electrode, and a gas supplier providing a sufficient amount of working gas to the first and second metal electrodes, thereby generating a continuous plasma shower within the conduit.

### BACKGROUND OF THE INVENTION

1. Field of the Invention

The present invention relates to a plasma discharge apparatus and method, and more particularly to an apparatus for sterilization of fluids using a continuous discharge plasma shower. Although the present invention is suitable for a wide scope of applications, it is particularly suitable for plasma treatment in heating, ventilation and air conditioning systems (HVAC) used in any closed environment, thereby providing virtually unrestricted applications regardless of the size or type of the enclosed environment.

2. Discussion of the Related Art

A plasma discharge has been widely used for treating surfaces of a variety of workpieces in many different industries. Particularly, a station for cleaning or etching electronic components, such as a printed circuit board (PCB), a lead frame, a microelectronic device and a wafer, has been employed in electronics industries since it provides advantages over the conventional chemical cleaning apparatus. For example, the plasma process occurs in a closed system instead of in an open chemical bath. Thus, the plasma process may be less hazardous and less toxic than the conventional chemical process. One example of a related background art plasma process and apparatus was disclosed in U.S. Pat. No. 5,766,404.

Another example of the related background art was disclosed in “Surface Modification of Polytetrafluoroethylene by Ar+ Irradiation for Improved Adhesion to Other Materials”, Journal of Applied Polymer Science, pages 1913 to 1921 in 1987, in which the plasma process was applied on the surfaces of plastic workpieces in an effort to improve wetability or bonding of the workpieces.

All of the background art plasma processes, however, are carried out on a workpiece. As a result, the background art plasma apparatus and processes are very limited in application.

### SUMMARY OF THE INVENTION

Accordingly, the present invention is directed to an apparatus and method for plasma treatment using a capillary electrode discharge plasma shower that substantially obviates one or more of problems due to limitations and disadvantages of the related art.

Another object of the present invention is to provide an apparatus for plasma treatment using a capillary electrode discharge plasma shower which can be applied in sterilization of fluids.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, a plasma apparatus for treating a fluid includes a fluid conduit, a first metal electrode and a second metal electrode mounted in the fluid conduit and receiving a potential, a capillary dielectric between the first and second metal electrodes, wherein the capillary dielectric has at least one capillary, a shield body surrounding at least a portion of the first metal electrode, and a gas supplier providing a sufficient amount of working gas to the first and second metal electrodes, thereby generating a continuous plasma shower within the conduit.

In another aspect of the present invention, a method for treating a fluid includes passing a fluid through a conduit, wherein the conduit comprises, a first metal electrode and a second metal electrode mounted in the fluid conduit and each receiving a potential, a capillary dielectric between the first and second metal electrodes, wherein the capillary dielectric has at least one capillary, and a gas supplier providing a sufficient amount of working gas to the first and second metal electrodes, applying a sufficient amount of working gas to the apparatus from a direction toward the fluid, applying a potential to each of the first and second metal electrodes, and generating a plasma shower emitting from the capillary dielectric within the path of the fluid passing. through the conduit.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a perspective view illustrating an apparatus for plasma treatment using a capillary discharge plasma shower according to the present invention.

FIG. 2 is a schematic view of a portion of the plasma treatment apparatus of FIG. 1.

FIG. 3 is an exploded view illustrating components of FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

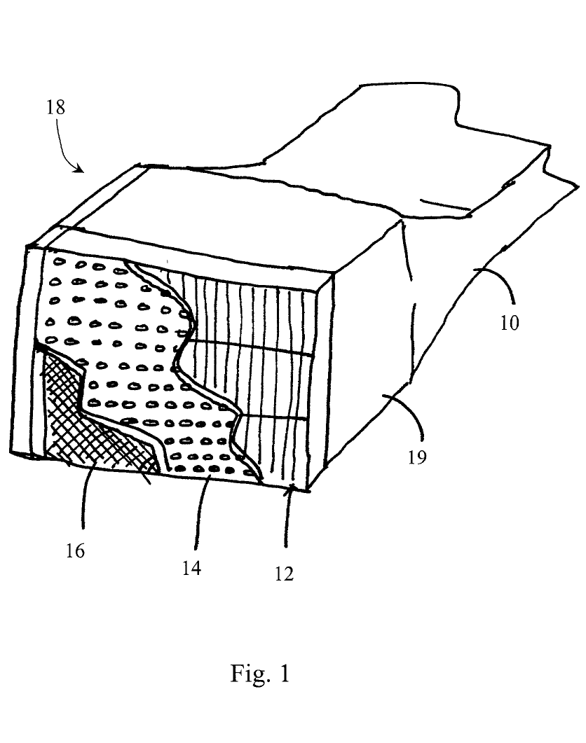

As shown in FIGS. 1-3, an apparatus for plasma treatment using a CED plasma shower according to a preferred embodiment includes a conduit 10, a first metal electrode 12, a capillary dielectric 14, a second metal electrode 16, a filter section 18 and a shield body 19. Depending on the type of fluid to be treated, a gas supplier 20 can provide working gas to the apparatus by way of a gas tube 22. For example, treatment of air would not require a working gas because the plasma shower would be created using the air to be treated.

The first metal electrode 12, for example, is connected to a power supply 24. In this arrangement, either a DC or a RF potential may be applied, for example, to the first metal electrode 12. In the case where an RF potential is applied, it is preferably in the range of 10 KHz to 200 MHz.

The first metal electrode 12 can be in the form of a fine mesh screen or filter having one or more holes that are sized to trap solid particles but permit fluid to pass through. One side of the capillary dielectric 14 is coupled to the first metal electrode 12 inside the shield body 19 while another side of the capillary dielectric 14 is outside the shield body 19 and exposed to the fluid.

The capillary dielectric 14 is between the first metal electrode 12 and the second metal electrode 16. The capillary dielectric 14 has at least one capillary. For example, the number of capillaries may range from one to thousands. The thickness of the capillary dielectric 12 may be in the range of 2 mm to 300 mm. A diameter of each capillary is preferably in the range of 200 μm to 30 mm.

A glow plasma discharge device using a perforated dielectric is disclosed in U.S. Pat. No. 5,872,426, which is incorporated herein by reference.

The shield body 19 surrounds the first metal electrode 12 and the capillary dielectric 14, so that it prevents unnecessary area from generating discharge. The shield body 19 is made of a dielectric material, for example.

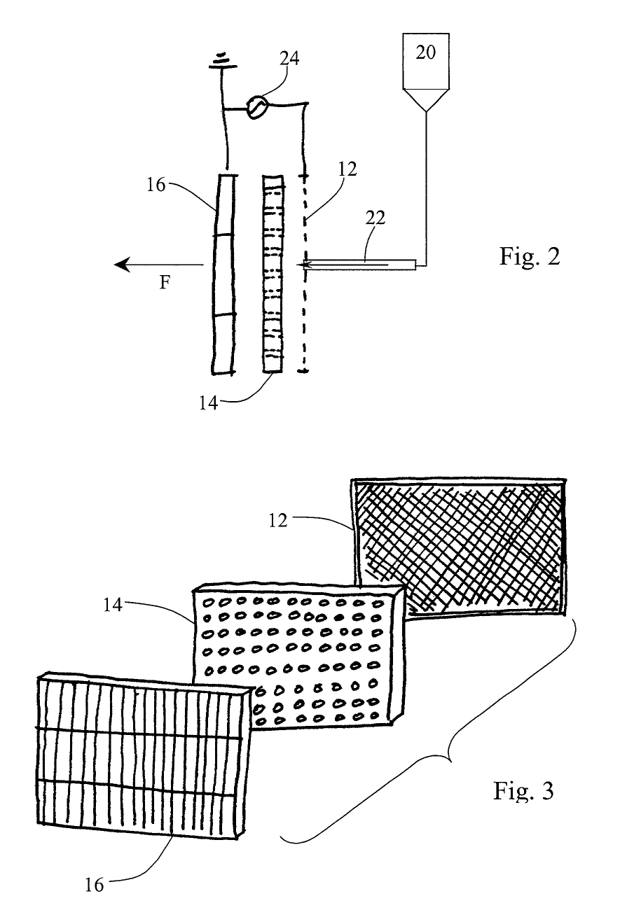

The gas supplied to the first metal electrode 12 passes through the each capillary formed in the capillary dielectric 14. Since a high electric field is maintained across the capillary dielectric 14, a high density discharge beam is generated in the capillary. The gas may be a carrier gas or a reactive gas depending upon a specific application of the apparatus. For example, when the apparatus is used for sterilizing HVAC air in hospitals, destruction of medical pathogens or chemicals in flow process, an appropriate reactive gas is selected for a desired chemical reaction. Thus, a CED plasma discharge is formed toward a fluid (not shown) passing through the apparatus as indicated at arrow F in FIG. 2.

The gas tube 22 made of a metal or a dielectric material, for example, is further coupled to the first metal electrode 12, so that gas is supplied by the gas supplier 20 through the gas tube 17. The working gas can be any gas; preferably, it can be Ar, He, O₂ or air, or any mixture of these gases.

A second metal electrode 16 can be mounted on the second side of the capillary dielectric 14. Preferably, the second metal electrode 16 is completely encapsulated in the capillary dielectric to prevent arcing between the electrodes 12, 16. The second metal electrode 16 is connected to ground. This provides a potential difference with respect to the first metal electrode 12. As such, virtually any kind of fluid, such as air circulating in an HVAC system, gases related to the destruction of medical pathogens and chemicals in flow can be treated by the apparatus of the present invention. In the preferred embodiment of the invention, the second metal electrode is in the form of a grate. However, the second metal electrode can take other forms such as, a metal screen, a grille, or other similar configuration that will permit the passage of fluid.

As described above, the apparatus for sterilization of fluids using a continuous capillary discharge atmospheric pressure plasma shower has the following advantages over the conventional plasma treatment apparatus.

The capillary electrode discharge (CED) shower of the present invention may be used for plasma treatment of any fluid circulating in an enclosed environment. Thus, it provides virtually unrestricted applications regardless of the size of the type of enclosed environment.

Moreover, in a sterilization process, the treatment by the CED plasma shower of the present invention is much more effective than the conventional AC barrier type plasma treatment.

It will be apparent to those skilled in the art that various modifications and variations can be made in the method and apparatus for treatment using a continuous capillary discharge atmospheric pressure plasma shower of the present invention without departing from the scope or spirit of the invention. Thus, it is intended that the present invention cover the modifications and variations of the invention provided they come within the scope of the appended claims and their equivalents.

What is claimed is:

1. A plasma apparatus for treating a fluid comprising:
a fluid conduit;
a first metal electrode and a second metal electrode mounted in the fluid conduit and receiving a potential;
a capillary dielectric between the first and second metal electrodes, wherein the capillary dielectric has at least one capillary;
a shield body surrounding at least a portion of the first metal electrode; and
a gas supplier providing a sufficient amount of working gas to the first and second metal electrodes, thereby generating a continuous plasma shower within the conduit.

2. The apparatus according to claim 1, further comprising a power supply providing a RF potential to the first metal electrode in the range of 10 KHz to 200 MHz.

3. The apparatus according to claim 1, wherein the potential includes either a DC or an RF potential.

4. The apparatus according to claim 1, wherein the capillary dielectric has a thickness in the range of 2 mm to 300 mm.

5. The apparatus according to claim 1, wherein the at least one capillary has a diameter in the range of 200 μm to 30 mm.

6. The plasma apparatus of claim 1, wherein the conduit includes an outlet; and
the first and second metal electrodes are mounted proximate to the outlet.

7. The plasma apparatus of claim 1, wherein the first metal electrode is a fine mesh screen.

8. The plasma apparatus of claim 7, wherein the second metal electrode is a grate.

9. The plasma apparatus of claim 8, wherein the fluid conduit is an HVAC duct.

10. The apparatus according to claim 1, wherein the shield body suppresses a plasma discharge except from the second side of the capillary dielectric.

11. The apparatus according to claim 1, wherein the capillary dielectric includes first and second sides, the first side is adjacent to the first metal electrode and the second side is adjacent to said second metal electrode.

12. The apparatus according to claim 11, wherein the first metal electrode has at least one opening in a surface adjacent to the first side of the capillary dielectric.

13. The apparatus according to claim 12, wherein the second metal electrode has at least one opening in a surface coupled to the second side of the capillary dielectric.

14. A method for treating a fluid comprising:
passing a fluid through a conduit, wherein the conduit comprises:
a first metal electrode and a second metal electrode mounted in the fluid conduit and each receiving a potential;
a capillary dielectric between the first and second metal electrodes, wherein the capillary dielectric has at least one capillary; and
a gas supplier providing a sufficient amount of working gas to the first and second metal electrodes;
applying a sufficient amount of working gas to the apparatus from a direction toward the fluid;
applying a potential to each of the first and second metal electrodes; and
generating a plasma shower emitting from the capillary dielectric within the path of the fluid passing through the conduit.

15. The method of claim 14, wherein plasma shower is generated within the conduit.

16. The method of claim 14, wherein the conduit further includes an outlet; and
the plasma shower is generated at the outlet.

17. The method of claim 14, wherein the step of generating a plasma shower includes sterilizing the fluid passing through the conduit.

18. The method of claim 14, wherein the fluid is air.
